(19) United States
(12) Patent Application Publication
(10) Pub. No.: US 2009/0297793 A1
(43) Pub. Date: Dec. 3, 2009

(54) Article of manufacture for providing a method of a grippable lace or cord

(76) Inventor: Adrian Daniel Yun, Renton, WA (US)

Correspondence Address: ADRIAN DANIEL YUN, 14631 SE 140TH ST, RENTON, WA, 98059, US

(21) Appl. No.: 12/454,339

(22) Filed: May 15, 2009

Related U.S. Application Data
(60) Provisional application No. 61/053,510, filed on May 15, 2008.

(51) Int. Cl. C08L 75/00; B32B 27/40

(52) U.S. Cl. 428/195.1; 524/589

(57) ABSTRACT

An article of manufacture that provides an integral protective coating that improves lace, cordage, rope, twine, or other tie substrates that will not untie under normal, high performance, or inclement conditions and is stainproof, waterproof, and safer than currently available products. This invention is typically used in fastening shoes, garments, webbing, bags, cinch, or other application where holding fast without slipping is advantages. A coating by example but not limited to, surrounding, permeating, striping, edging, encapsulating the tie substrate consisting of either silicone, rubber, latex, urethane, polyurethane, polyethylene, or other coating type materials that present the desired properties.

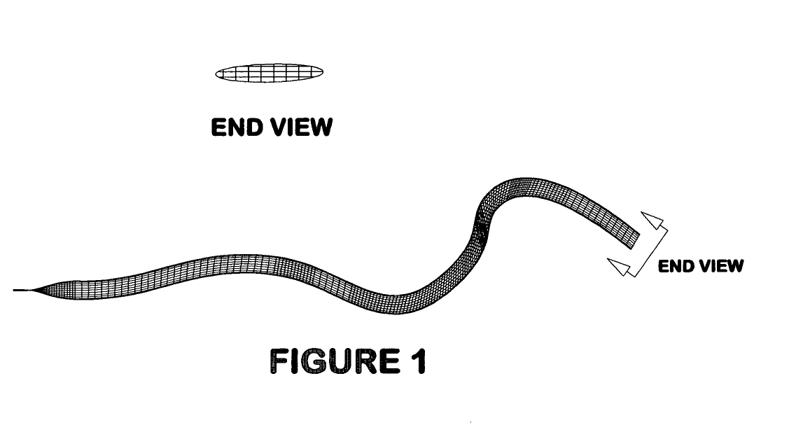

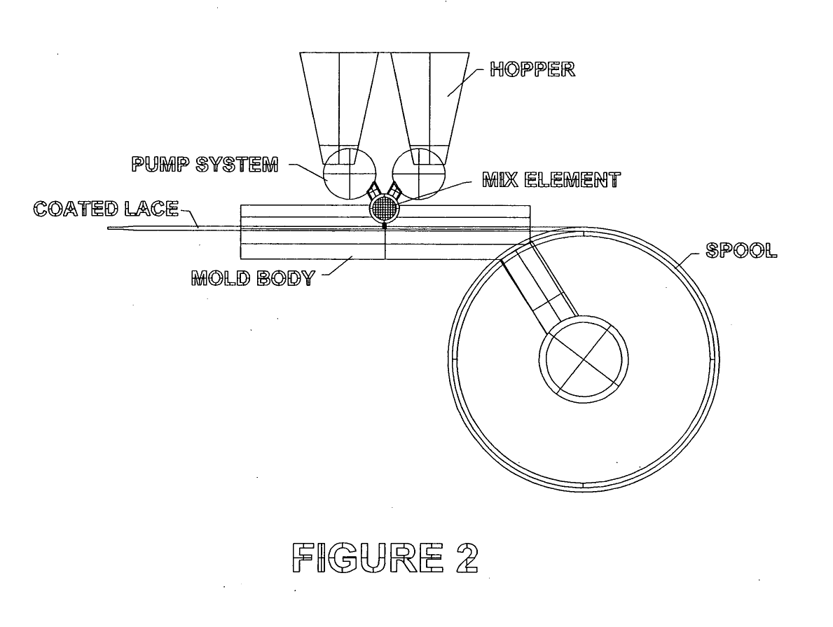

### CROSS REFERENCE TO RELATED APPLICATIONS

This is a continuation of Ser. No. 61053510, filed on May 15, 2008, and is also based on provisional application Ser. No. 61053510, filed on May 15, 2008.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of mechanics, and more specifically to an article of manufacture for providing integral protective coating that improves lace, cordage, rope, twine, or other tie properties providing a product that will not untie under normal, high performance, or inclement conditions while being stainproof, waterproof, and safer than currently available products.

The development of this invention was initially driven by critical requirements in the moving industry. The daily work footwear typically is an expensive pair of high quality, name brand, steel toe boots. These boots are functional in most ways but one. The laces constantly come untied. Many work environments require carrying heavy objects up and down stairs, across ramps, and other uneven surfaces. The risk of tripping and having a dangerous accident is high enough without the added risk of tripping over a shoe lace. The invention of a boot lace that stays tied without cumbersome double or even triple knots is required. This invention solves the problem of loosening knots that eventually come untied. This invention also adds additional benefits to the designer in creating new and exciting models of laces for the purpose of attracting sales in multiple industries.

Laces have been employed in the boot and shoe industry for many years, and while they have served the purpose of fastening the footwear to the foot, not much attention has been applied to chronic loosening and dangers that are associated with loose laces. One attempt to alleviate this problem is to add a loop with a regular spacing along the edge or two edges of the lace as represented in the form of the “sure lace”. The “sure lace” is a partial attempt to correct the loosing problem but in doing so create additional problems such as catching, collecting, and fraying at the exposed loops. Another attempt at correcting the loosening problem is the “curly laces” that consist of a woven lace with a particular weave causing a continual twist in the lace. The “curly laces” also will cause additional problems like catching, collecting, and fraying due to the twisting that expose none uniform stress areas that can wear unevenly reducing the strength and increasing breakage. One additional invention is called the “knotty boy” lace that incorporates a stretchy knot at regular spacing. The problem with the stretchy knot is that the lace now will stretch when it could be a detriment to the fastening of the footwear. The “knotty boy” lace also incorporates areas that can catch, collect, and fray due to uneven bumps or knots that extend beyond the normal lace size.

Laces are typically used in clothing and footwear to removably and adjustably bind two opposing components together. Laces are a favorable alternative to buckles, zippers, clasps, and other similar securing mechanisms because they are less obtrusive, more comfortable, and more adaptable to specific lengths. However, laces suffer a major drawback in that the knots typically used to yield removability simultaneously result in unintentional loosening and separation. A common workaround to this problem is using a double-tie method. This workaround is not always practiced for a multitude of reasons. Primarily, the double-tie results in a knot that is more difficult to remove, less attractive, and more cumbersome to tie. Accordingly, the problem of unintentional loosening and separation persists, which results in inconvenience and safety issues. While the inconvenience of constantly tying and re-tying loosened laces is obvious, the risk of tripping over untied laces is even more troubling. Accordingly, while desirable results have been achieved in prior art, there exists much room for improvement. Typical methods that have been used to improve the tying characteristics use embodiments such as, open loops, exposed bumps, rough edges, expanding knots and a mechanical chinch. The problem exist when the lace is exposed to a type of extreme ware that abrades exposed components whereby weakening the substrate to the point of failure. The prior art employs cumbersome techniques and gimmicks that cause catching, collecting, and fraying. What is lacking in prior art is the ability to protect the substrate while also improving the grip. What is needed then is a system and method that provides a gripping lace coating that can have multiple improved effects while providing a protective coating, an enhanced possibility of design, and enhanced probability of marketing and increased sales.

### BRIEF SUMMARY OF THE INVENTION

The primary object of the invention is To improve on prior art and provides for better knots that will stay tied.

Another object of the invention is to improve prior art by applying a coating that is stain proof, weather proof, oil proof, and chemical resistant.

Another object of the invention is To embody a property in the coating that enhances properties in moderate to extreme weather conditions where flexibility and sustained mechanical integrity is a benefit.

A further object of the invention is To provide a safer and more convenient product that reduces tripping accidents and injury by staying tied and also reduces the inconvenience of having to stop and retie shoes.

Yet another object of the invention is To provide a product for children that will stay tied without needing to use the double knot, thereby making the knot easer to purposely untie.

Still yet another object of the invention is Performs a needed function while preserving the designers original aesthetics of the primary product being produced.

Another object of the invention is To give a designer the ability to create far more attractive products that add or create new and unlimited special features that bring new forms of market and and increased sales.

Another object of the invention is To create a longer lasting product that prevents premature breakdown of the aforementioned substrate due to exposure to chemicals, dirt, oil, water, and other contaminants.

A further object of the invention is To also create a longer lasting product buy protecting the substrate for extreme weather conditions.

Yet another object of the invention is To provide an eco friendly product that is safe for the environment with non-toxic coatings.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for providing integral protective coating that improves lace, cordage, rope, twine, or other tie substrates and provides a product that will not untie under normal, high performance, or inclement conditions while being stainproof, waterproof, and safer than currently available products comprising: A substrate material typically used in fastening shoes, garments, webbing, bags, cinch, or other application where holding fast without slipping would be advantages, and where previous art has been unsatisfactory, A coating by example but not limited to, surrounding, permeating, striping, edging, encapsulating the substrate consisting of either silicone, rubber, latex, urethane, polyurethane, polyethylene, or other coating type materials that present the desired properties, A pattern, stamp, emblem, design, ridge, bump or other mechanical embodiment that enhances the prior art substrate material, A color, pigment, tone, or other typical enhancement that can be added by coating the prior art substrate material, A flexible or solid additive to the coating previously mentioned, that enhances the properties of the prior art substrate materials prior limited function, A shape that can be molded in the coating process that in cross section would be represented but not limited to a diamond, oval, round, square, rectangle, or even complex form not previously possible in prior art, A coating as previously stated that is full length, on just the ends, or at specific spacing, and produces specific desired functions in the fastening process, A coating that could encapsulate the ends of the substrate in order to reduce the diameter of the ends for better threading, thereby eliminating the necessity of tipping the ends. The encapsulation could also reduce the diameter in multiple, equal, or unequal, spacing along the substrate, A coating that provides for but is not limited to a finish ranging from dull to high gloss and could be consistent or vary along the length or girth of the substrate, and A clear to opaque coating that could include eye catching glitter, flake, sequence, or other additive that might enhance the design or look of the substrate.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. <1> is a perspective view of the invention.

FIG. <2> is a perspective view of one possible coating machine for the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

This invention relates generally to mechanics, and more specifically, to systems and methods for providing a grippable composite lace. Specific details of certain embodiments of the invention are set forth in the following description to provide a thorough understanding of such embodiments. The present invention may have additional embodiments, may be practiced without one or more of the details described for any particular described embodiment, or may have any detail described for one particular embodiment practiced with any other detail described for another embodiment.

In one embodiment, the invention includes a composite lace composed of a grippable compound integrated into a traditional lace whereby the grippable compound facilitates the composite lace gripping to itself when tied. The traditional lace is composed of many possible substrates such as, leather, cotton, jute, hemp, synthetic fiber, or other similar material. Synthetic fibers include but are not limited to, rayon, acetate, nylon, modacrylic, olefin, acrylic, polyester, PLA, vinyon, saran, spandex, vinalon, aramid, modal, pbi, sulfar, lyocell, dyneema, spectra, M-5, orlon, zylon, vectran, acrylonitrile, glass fiber, and metallic fiber. The gripping compound is composed of rubber, latex, silicone, polyurethane, or other similar compound that exhibits elastic and/or grippable properties.

In one particular embodiment, the gripping compound is interwoven within the traditional lace to provide a composite lace that includes both the gripping compound and synthetic fiber. When the composite lace is tied, the elastic and/or grippable properties of the interwoven gripping compound restrict unintentional loosening or untying of the composite lace. Yet, the composite lace substantially retains the appearance of the traditional lace.

In yet another embodiment, the gripping compound is embedded within and along the length of the traditional lace, such as a series of small grommets or beads. The embedded gripping compound may protrude from or reside flush with the surface of the traditional lace. Furthermore, the embedded gripping compound may define an aperture or may be solid. Again, when the composite lace is tied, the elastic and/or adhesion properties of the embedded grippable compound restrict unintentional loosening or untying of the composite lace. Yet, the composite lace substantially retains the appearance of the traditional lace.

In one embodiment, the gripping compound is interwoven or embedded within the traditional lace only in or along the area used for tying. For instance, the composite lace may have the gripping compound limited towards the end of the lace. In a further embodiment, the composite lace is composed of the gripping compound without any or a substantial amount of the traditional lace. In a alternate embodiment, the grip compound is disposed within an interior channel defined by the traditional lace.

In yet an additional embodiment would be, a coating by example but not limited to, surrounding, permeating, striping, edging, encapsulating the substrate could include embossed art, patent numbers, logos, graphics or other design features that could enhance the attractiveness of the article.

In one embodiment, a pattern, stamp, emblem, design, ridge, bump or other mechanical embodiment that enhances the prior art substrate material.

In yet an additional embodiment, a color, pigment, tone, or other typical enhancement that can be added by coating the prior art substrate material.

In one additional embodiment, a flexible or solid additive, like a grainy material, to the coating previously mentioned, that enhances the properties of the prior art substrate materials prior limited function.

In addition an embodiment as, a shape that can be molded in the coating process that in cross section would be represented but not limited to a diamond, oval, round, square, rectangle, or even complex form not previously possible in prior art.

In one more embodiment, a coating that could encapsulate the ends of the substrate in order to reduce the diameter of the ends for better threading, thereby eliminating the necessity of tipping the ends. The encapsulation could also reduce the diameter in multiple, equal, or unequal, spacing along the substrate.

In one embodiment, a coating that provides for but is not limited to a finish ranging from dull to high gloss and could be consistent or vary along the length or girth of the substrate.

In one design embodiment, a clear to opaque coating that could include eye catching glitter, flake, sequins, or other additive that might enhance the design or look of the substrate.

In certain embodiments, the composite lace is usable in footwear, clothing, or articles of manufacture, such as shoelaces, bathing suit drawstrings, athletic drawstrings, backpacks, or in any other context where traditional laces are found.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture for providing integral protective coating that improves lace, cordage, rope, twine, or other tie substrates and provides a product that will not untie under normal, high performance, or inclement conditions while being stainproof, waterproof, and safer than currently available products comprising:

2. A substrate material typically used in fastening shoes, garments, webbing, bags, cinch, or other application where holding fast without slipping would be advantages, and where previous art has been unsatisfactory;

3. A coating by example but not limited to, surrounding, permeating, striping, edging, encapsulating the substrate consisting of either silicone, rubber, latex, urethane, polyurethane, polyethylene, or other coating type materials that present the desired properties;

4. A pattern, stamp, emblem, design, ridge, bump or other mechanical embodiment that enhances the prior art substrate material;

5. A color, pigment, tone, or other typical enhancement that can be added by coating the prior art substrate material;

6. A flexible or solid additive to the coating previously mentioned, that enhances the properties of the prior art substrate materials prior limited function;

7. A shape that can be molded in the coating process that in cross section would be represented but not limited to a diamond, oval, round, square, rectangle, or even complex form not previously possible in prior art;

8. A coating as previously stated that is full length, on just the ends, or at specific spacing, and produces specific desired functions in the fastening process;

9. A coating that could encapsulate the ends of the substrate in order to reduce the diameter of the ends for better threading, thereby eliminating the necessity of tipping the ends. The encapsulation could also reduce the diameter in multiple, equal, or unequal, spacing along the substrate;

10. A coating that provides for but is not limited to a finish ranging from dull to high gloss and could be consistent or vary along the length or girth of the substrate; and

11. A clear to opaque coating that could include eye catching glitter, flake, sequence, or other additive that might enhance the design or look of the substrate.
